(19) United States
(12) Patent Application Publication
(10) Pub. No.: US 2021/0378407 A1
(43) Pub. Date: Dec. 9, 2021

(54) COMBINED SEATING AND SLEEPING FURNITURE AND KIT

(71) Applicant: Froli Kunststoffwerk Heinrich Fromme, Inhaberin Margret Fromme-Ruthmann e. Kfr., Schloß Holte-Stukenbrock (DE)

(72) Inventor: Margret Fromme-Ruthmann, Schloß Holte-Stukenbrock (DE)

(21) Appl. No.: 17/337,470

(22) Filed: Jun. 3, 2021

(30) Foreign Application Priority Data
Jun. 4, 2020 (DE) 202020103217.8

(51) Int. Cl. A47C 17/04; A47C 17/52

(52) U.S. Cl. CPC A47C 17/04; A47C 17/52

(57) ABSTRACT

Provided is an item of combined seating and sleeping furniture including: a base body, in which a storage space is formed; and a lid which is arranged on the base body and is displaced between an open position in which a lid-side opening of the base body is open towards the storage space and a closed position in which the lid-side opening is closed. The lid has a seating surface on one flat side and an arrangement of spring elements on an opposite flat side by means of which a resilient mattress support surface is provided for a lying mattress. The lid is displaced between a first closed position in which the flat side with the seating surface is arranged on the outer side and a second closed position in which the opposite flat side with the arrangement of spring elements is arranged on the outer side.

### CROSS-REFERENCE TO RELATED APPLICATIONS

This application claims priority to German Application No. 202020103217.8, having a filing date of Jun. 4, 2020, the entire contents of which are hereby incorporated by reference.

### FIELD OF TECHNOLOGY

The following relates to an item of combined seating and sleeping furniture as well as a kit for an item of combined seating and sleeping furniture.

### BACKGROUND

Seating furniture provides a seating surface for the user. In the case of sleeping furniture a lying surface is provided for the user. The requirements for the configuration of the corresponding surface, in particular relating to an upholstery, are different for the seating surface on the one hand and the lying surface on the other hand and are therefore difficult to reconcile when a combined usage is intended. In the case of sleeping furniture, the lying surface can be configured individually for different users whereby a sleeping mattress is designed which corresponds to the individual requirements of the respective user. Here it is known to provide a resilient mattress support surface whereby a plurality of spring elements are arranged distributed over a base in such a manner that the spring elements provide a mattress support surface. However, such a resilient base for the sleeping mattress is not suitable as a seating surface even if a different mattress were to be placed thereon instead of the sleeping mattress.

### SUMMARY

An aspect relates to provide an item of combined seating and sleeping furniture as well as a kit for this which enables a combined usage for sitting and sleeping for various application situations in a simple manner.

According to one aspect, a combined seating and sleeping furniture is provided comprising a base body in which a storage space is formed and a lid which is arranged on the base body and can be displaced between an open position in which a lid-side opening of the base body is open towards the storage space and a closed position in which the lid-side opening is closed. The lid has a seating surface on one flat side and an arrangement of spring elements on an opposite flat side by means of which a resilient mattress support surface is provided for a lying mattress. The lid can be displaced between a first closed position in which the flat side with the seating surface is arranged on the outer side and a second closed position in which the opposite flat side with the arrangement of spring elements is arranged on the outer side.

According to a further aspect, a kit is provided for a combined seating and sleeping furniture, comprising a base body, in which a storage space is formed and a lid which can be mounted on the base body in such a manner that the lid can be displaced between an open position in which a lid-side opening of the base body is open towards the storage space and a closed position in which the lid-side opening of the storage space is closed. The lid has a seating surface on one flat side and an arrangement of spring elements on an opposite flat side by means of which a resilient mattress support surface is provided for a lying mattress. The lid after arrangement on the base surface can be displaced between a first closed position in which the flat side with the seating surface is arranged on the outer side and a second closed position in which the opposite flat side with the arrangement of spring elements is arranged on the outer side.

The furniture is adapted to be used both as seating furniture and also as sleeping furniture. Here seating surface and mattress support surface for the lying mattress are formed on the lid and as a result can be designed and optimized independently of one another for the respective surface. The conversion between seating furniture and sleeping furniture is made possible in a simple manner by turning the lid so that either the flat side with the seating surface or the opposite flat side with the arrangement of spring elements forms the lid-side surface of the furniture. In order to provide the lying mattress support surface, spring elements are provided on the opposite flat side of the lid which provide a suitable mattress support surface for the sleeping furniture. A sleeping or lying mattress can then be placed thereon in order to provide the sleeping or lying surface when the furniture is used as sleeping furniture.

The spring elements of the arrangement of spring elements can each be formed with a base or an element foot which is arranged on the lid, a support plate or an element support which provides a support surface and at least one spring arm or leg which extends between the base and the support plate or parts thereof. The spring elements can be configured to provide a plurality of separate or interconnected support plates (also part-support plates) to which respectively one spring arm emanating from the base is assigned. The support plates then form a complete element support for the spring element. The support plates of the spring elements of the arrangement together form the mattress support surface on the lid of the combined seating and sleeping furniture. Spring elements are known as such in various embodiments. They can be mounted detachably or non-detachably on the lid.

The arrangement of spring elements can be configured to substantially completely cover a surface of the lid on the opposite flat side. In this embodiment, the mattress support surface provided by the spring elements can extend substantially over the entire surface of the lid. In these or other embodiments the spring elements of a regular arrangement can be fastened accordingly to the lid. When the lid is arranged in the first closed position, the arrangement of spring elements in this or other embodiments is located on the underside of the lid and can thus project, at least partially into the storage space of the base body.

The lid can be arranged in the closed position in a lid receptacle on the base body and by this means can be secured at least against a horizontal displacement relative to the base body. In this way, it is prevented that the lid is unintentionally displaced during use relative to the base body whether as a seating surface or as lying mattress support surface. In order to secure the lid in the lid receptacle, positioning sections assigned to one another can intermesh, in particularly positively, on the lid and on the lid receptacle of the base body. The lid can be partially let into a recess on the wall of the base body when it is arranged in the closed position. For example, an indentation can be provided on the wall of the base body which can be configured to be circumferentially continuous or interrupted on the edge side, into which the lid is inserted. In one configuration the lid can be arranged with the lid surfaces flush with an upper edge of side walls of the base body in the closed position, wherein the spring elements in particular project upwards when the lid is arranged in the closed position.

The lid can be arranged removably on the base body. In this configuration the lid can be removed completely from the base body in order, for example, to make a change between the first and the second closed position.

The lid can be arranged by means of a folding-sliding mechanism on the lid in such a manner that the lid can be displaced with the aid of a folding-sliding movement between the first and the second closed position. This configuration can be provided alternatively or additionally to the removability of the lid from the base body. The lid can be displaced by means of a folding-sliding movement between the two closed positions. For example, guides can be provided for this on the base body on opposite sides in which assigned protrusions formed on the lid are guided for displacement during the folding-sliding movement, wherein this displacement movement along the guides is combined or superposed with a sliding movement in order to bring either the flat side with the seating surface or the opposite flat side with the arrangement of spring elements onto the upper side in order to provide the seating or the sleeping furniture.

The lid can be arranged by means of a pivoting mechanism on the lid in such a manner that the lid can be displaced between the first and the second closed position with the aid of the pivoting movement. The pivoting movement can be provided alternatively or additionally to the folding-sliding mechanism. Also, the pivoting mechanism can be combined with the removability of the lid from the base body. With the pivoting mechanism it can be provided that the lid is rotatable about an axis of rotation running substantially centrally to the lid in order to bring either the flat side or the opposite flat side upwards.

The lid can be displaced between the open and the closed position by means of a pivoting movement. For this purpose, the lid can, for example, be pivotable about a pivot axis formed on the lid at the edge.

The seating surface can be formed with a seating upholstery. The seating upholstery for the seating surface can be attached detachably or non-detachably to the lid. A detachable mounting can be executed, for example, by means of a Velcro or press stud fastening. The seating upholstery can have one or more layers.

The base body can have grip elements in the region of side walls. Grip elements can be provided on the base body, for example, on opposite sides. A design as a grip recess can be provided. Alternatively or additionally, one or more gaps can be provided in the wall of the base body which are configured as grip elements. Additionally or as an alternative embodiment, a grip elements can be provided on the lid, in particular for gripping the lid during displacement between the first and the second closed position.

The storage space can be designed as a storage space which is closed on all sides when the lid is arranged in the closed position. In this configuration the storage space is provided in a closed box. In this or other embodiments any objects can be accommodated herein.

The combined seating and sleeping furniture can be configured as furniture from the following group: interior furniture and built-in furniture for campervans or caravans. The combined seating and sleeping furniture can be used as interior furniture in buildings or apartments. The flexible use as seating and sleeping furniture is of particular advantage in combined spaces, in particular also in campervans or caravans. Not only there does the combined use as seating and sleeping furniture and also the provision of storage space prove to be advantageous properties.

The previously explained embodiments can also be provided accordingly combined with the kit for the combined seating and sleeping furniture.

### BRIEF DESCRIPTION

Some of the embodiments will be described in detail, with reference to the following figures, wherein like designations denote like members, wherein:

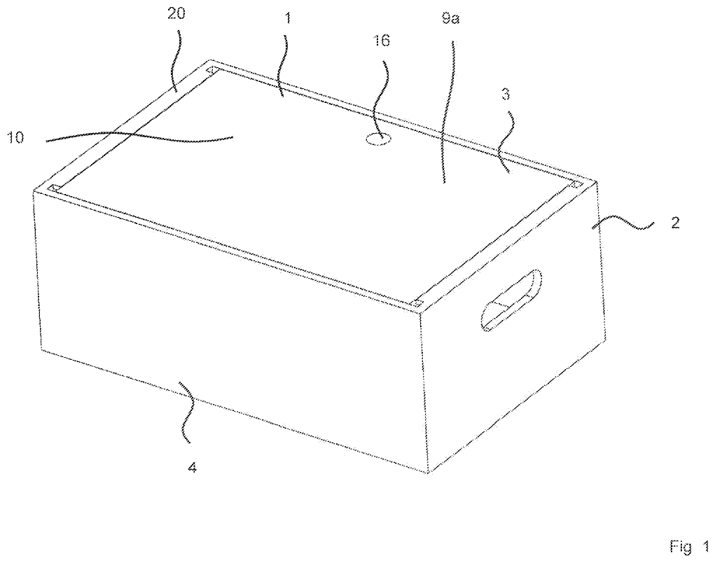

FIG. 1 shows a schematic perspective view of an item of combined seating and sleeping furniture in which a lid is arranged in a first closed position in such a manner that a seating surface is provided on the lid side;

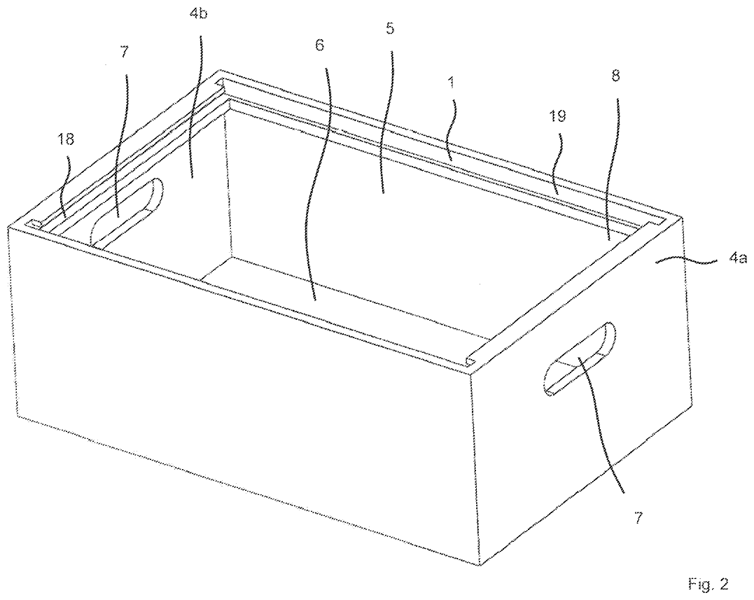

FIG. 2 shows a schematic perspective view of a base body of the combined seating and sleeping furniture from FIG. 1 with the lid removed;

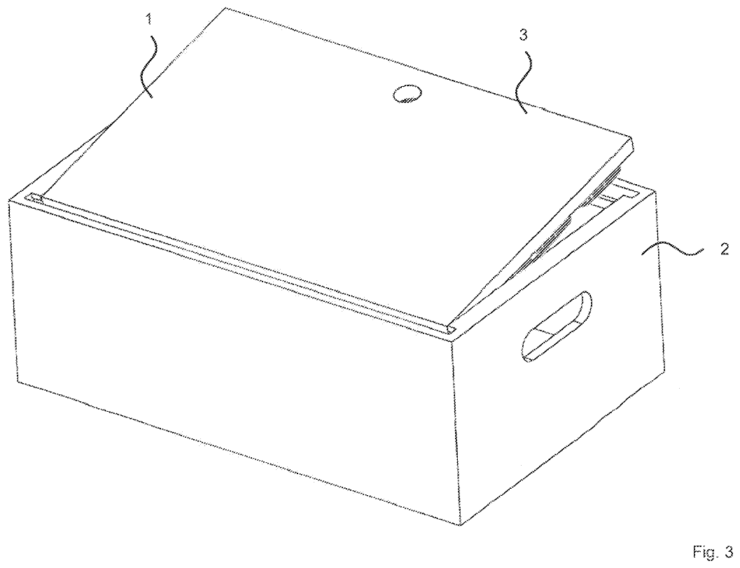

FIG. 3 shows a schematic perspective view of the combined seating and sleeping furniture from FIG. 1 wherein the lid is pivoted into an open position;

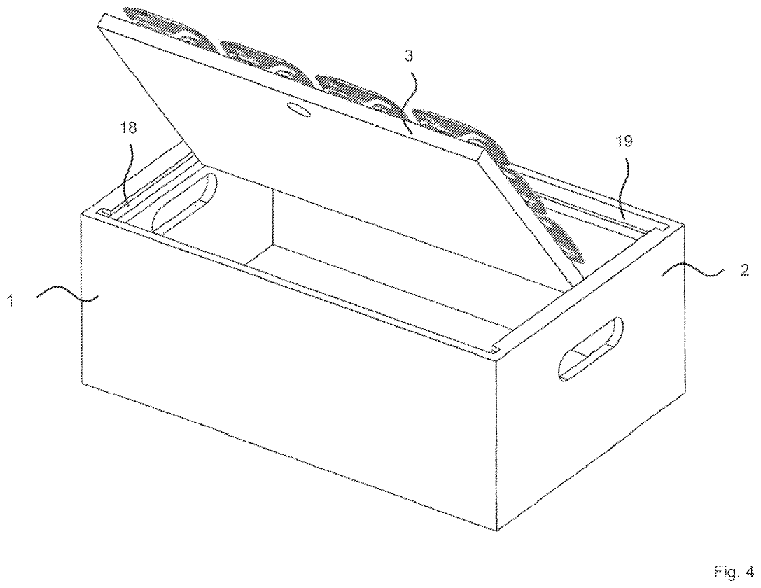

FIG. 4 shows a schematic perspective view of the combined seating and sleeping furniture from FIG. 1, wherein the lid is pivoted further open and at the same time displaced;

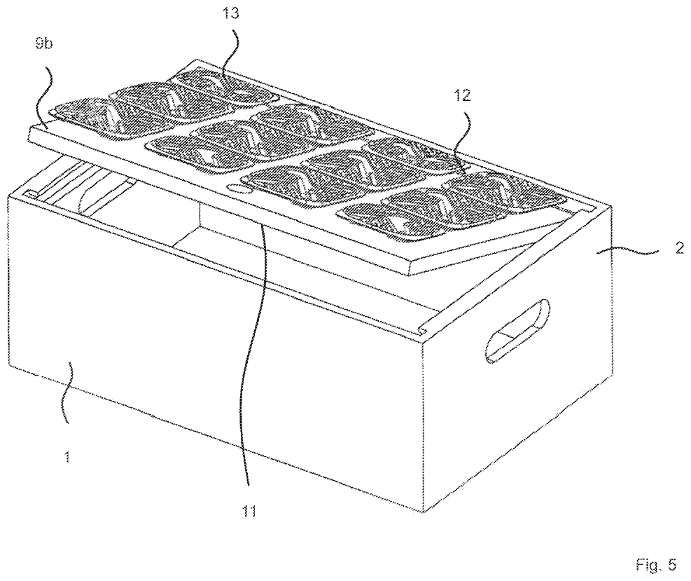

FIG. 5 shows a schematic perspective view of the combined seating and sleeping furniture from FIG. 1, wherein the lid is pivoted over in such a manner that an arrangement of spring elements points upwards;

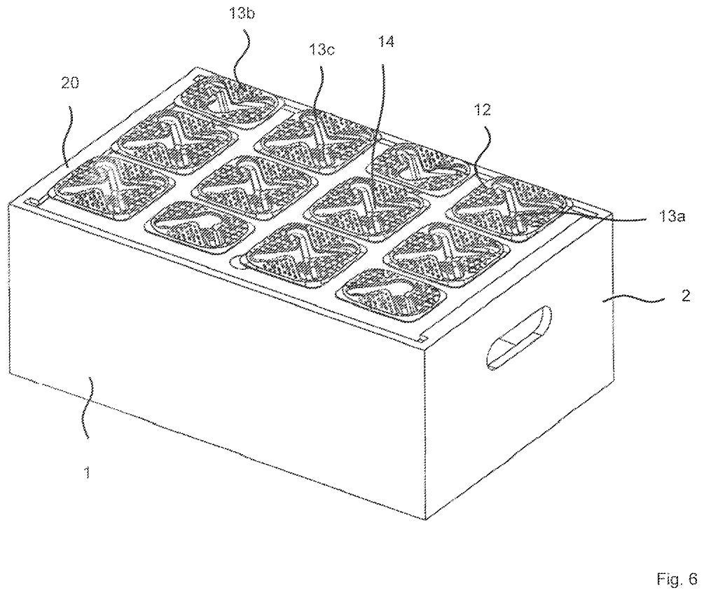

FIG. 6 shows a schematic perspective view of the combined seating and sleeping furniture from FIG. 1, wherein the lid is again arranged in a closed position in such a manner that a mattress support surface is provided in the lid side;

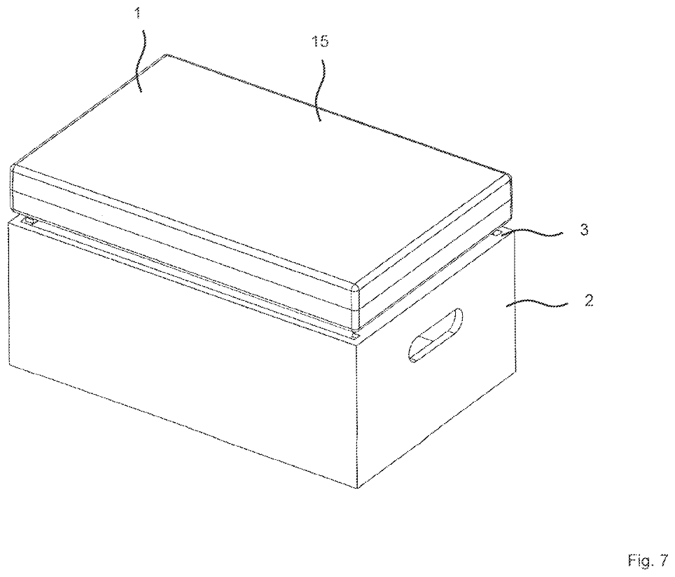

FIG. 7 shows a schematic perspective view of the combined seating and sleeping furniture from FIG. 1, wherein a lying mattress is placed on the arrangement of spring elements;

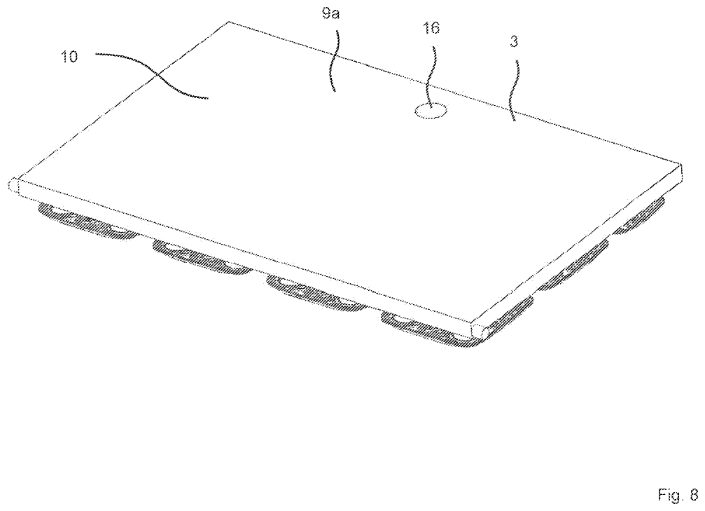

FIG. 8 shows a schematic perspective view of the lid of the combined seating and sleeping furniture from FIG. 1 with the seating surface at the top; and

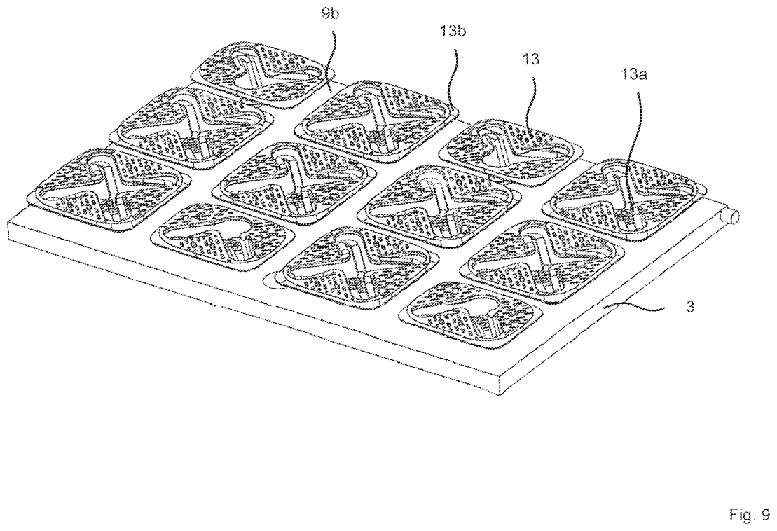

FIG. 9 shows a schematic perspective view of the lid of the combined seating and sleeping furniture from FIG. 1 with the arrangement of spring elements at the top.

### DETAILED DESCRIPTION

FIGS. 1 to 9 shows schematic perspective views of an item of combined seating and sleeping furniture 1 with a base body 2 and a lid 3.

According to FIGS. 1 and 2, the base body 2 has a wall with side walls 4 which surround a storage space 5. At the bottom the storage space 5 is delimited by a base 6. Grip elements 7 which are designed as gaps are provided in opposite side walls 4a, 4b. In the diagram in FIG. 2 the lid 3 is removed from the base body 2 so that a lid-side opening 8 to the storage space 5 is completely open. Any items can then be stowed in the storage space 5.

According to FIGS. 3 to 6, the lid 3 is displaced by means of a pivoting-sliding movement in such a manner that a seating surface 10 formed on a flat side 9a of the lid 3 is initially arranged on the lid side (cf. FIG. 1) and then on an underside 11 of the lid 5 (cf. FIG. 5). After a complete turning over of the lid 3, an arrangement of spring elements 12 with spring elements 13 is arranged on the lid side which is formed on an opposite flat side 9b of the lid 3. The spring elements 13 each have a base 13a, a support plate 13b and spring arms or legs 13c extending between the base 13a and the support plate 13b. By means of the support plates 13b a mattress support surface 14 is provided in order to configure the combined seating and sleeping furniture 1 as sleeping furniture in which, according to FIG. 7, a sleeping or lying mattress 15 is then arranged on the lid 3.

During displacement between the closed position in FIG. 1 and the (also) closed position in FIG. 6, the lid 3 can be gripped by the user by means of a grip element 16 on the lid 3. When turning over the lid 3 protrusions 17 which are formed on the lid 3 are guided in associated guides 18 on the base body 2 so that the lid 3 executes a combined sliding and folding or pivoting movement.

According to the illustrations in FIG. 1 and FIG. 6, the lid 3 is arranged in the respectively closed position in a lid receptacle 19 and thus secured against any horizontal displacement during use both as seating surface and also as mattress support surface. In the exemplary embodiment shown the lid 3 is arranged with its surface flush with lid-side edge surfaces 20 of the side walls 4 of the base body 2, which is shown in particular in FIGS. 1 and 6.

In an alternative embodiment the lid 3 can be displaced about a pivot axis or axis of rotation which extends substantially centrally to the lid 3 in order to thus bring the various flat sides 9a, 9b of the lid 3 upwards by means of turning over.

The base body 2 and the lid 3 can consist of the same or different materials. For example, a design comprising one or more of the following materials can be provided: plastic, wood and metal.

In the exemplary embodiment in FIG. 1, the seating surface 10 is formed merely with the lid 3. It can alternatively be provided to arrange a single- or multi-layer upholstery on the lid 3 in the region of the seating surface 10, whether this be detachably or non-detachably.

The combined seating and sleeping furniture 1 can be used for interior design in housings or buildings. Comparably a use as seating and sleeping furniture in a campervan or a caravan is possible.

Although the present invention has been disclosed in the form of preferred embodiments and variations thereon, it will be understood that numerous additional modifications and variations could be made thereto without departing from the scope of the invention.

For the sake of clarity, it is to be understood that the use of “a” or “an” throughout this application does not exclude a plurality, and “comprising” does not exclude other steps or elements.

1. A combined seating and sleeping furniture comprising:
a base body, in which a storage space is formed; and
a lid which is arranged on the base body and is displaced between an open position in which a lid-side opening of the base body is open towards the storage space and a closed position in which the lid-side opening is closed;
wherein the lid has a seating surface on one flat side and an arrangement of spring elements on an opposite flat side of which a resilient mattress support surface is provided for a lying mattress; and
wherein the lid is displaced between a first closed position in which the flat side with the seating surface is arranged on the outer side and a second closed position in which the opposite flat side with the arrangement of spring elements is arranged on the outer side.

2. The combined seating and sleeping furniture according to claim 1, wherein the spring elements of the arrangement of spring elements are each formed with
a base, which is arranged on the lid,
a support plate, of which a support surface is provided and
a spring arm which extends between the base and the support plate.

3. The combined seating and sleeping furniture according to claim 1, wherein the arrangement of spring elements is configured to substantially completely cover a surface of the lid on the opposite flat side.

4. The combined seating and sleeping furniture according to claim 1, wherein in the closed position the lid is arranged in a lid receptacle on the base body and is thereby secured against a horizontal displacement relative to the base body.

5. The combined seating and sleeping furniture according to claim 1, wherein the lid is arranged removably on the base body.

6. The combined seating and sleeping furniture according to claim 1, wherein the lid is arranged with a folding-sliding mechanism on the lid in such a manner that the lid is displaceable between the first and second closed position with the aid of a folding-sliding movement.

7. The combined seating and sleeping furniture according to claim 1, wherein the lid is arranged with a pivoting mechanism on the lid in such a manner that the lid is displaceable between the first and the second closed position with the aid of a pivoting movement.

8. The combined seating and sleeping furniture according to claim 1, wherein the lid is displaceable between the open and the closed position with a pivoting movement.

9. The combined seating and sleeping furniture according to claim 1, wherein the seating surface is formed with a seat upholstery.

10. The combined seating and sleeping furniture according to claim 1, wherein the base body has grip elements in the region of the side walls.

11. The combined seating and sleeping furniture according claim 1, wherein the storage space is provided as a storage space closed on all sides when the lid is in the closed position.

12. The combined seating and sleeping furniture according claim 1, adapted as furniture from the following group: interior furniture and built-in furniture for campervan or caravan.

13. A kit for an item of combined seating and sleeping furniture, comprising
a base body, in which a storage space is formed; and
a lid which is mounted on the base body in such a manner that the lid is displaced between an open position in which a lid-side opening of the base body is open towards the storage space and a closed position in which the lid-side opening of the storage space is closed;
wherein the lid has a seating surface on one flat side and an arrangement of spring elements on an opposite flat side of which a resilient mattress support surface is provided for a lying mattress; and
wherein the lid after arrangement on the base surface is displaced between a first closed position in which the flat side with the seating surface is arranged on the outer side and a second closed position in which the opposite flat side with the arrangement of spring elements is arranged on the outer side.
